(19) United States
(12) Patent Application Publication
(10) Pub. No.: US 2026/0195786 A1
(43) Pub. Date: Jul. 9, 2026

(54) Method and System for estimating construction costs using BIM model and Graph Neural Networks model

(71) Applicant: UIF (University Industry Foundation), Yonsei University, Seoul (KR)

(72) Inventors: Ghang Lee, Seoul (KR); Suhyung Jang, Seoul (KR); Minkyeong Park, Seoul (KR); Jaekun Lee, Seoul (KR)

(21) Appl. No.: 19/407,222

(22) Filed: Dec. 3, 2025

(30) Foreign Application Priority Data
Jan. 9, 2025 (KR) 10-2025-0003187
Jun. 20, 2025 (KR) 10-2025-0081678

(51) Int. Cl. G06Q 30/0201; G06Q 10/0875

(52) U.S. Cl. CPC G06Q 30/0206; G06Q 10/0875

(57) ABSTRACT

Disclosed herein are a method and system for estimating construction costs by utilizing a BIM model and a graph neural network model. The method includes: step S100 in which attribution information and connection information are extracted and converted into a graph data format; step S200 in which a graph neural network model is trained and constructed by using the graph data as training data; step S300 in which the geometric attribute information and connection information for each building component are extracted and converted into the graph data format, the converted data is input to the constructed graph neural network model to predict functional requirements and type classification codes, and the results of the prediction are mapped to the BIM model; and step S400 in which the attribute information is extracted from the mapped BIM model, a BOQ is generated for each building component, and construction costs are calculated.

### CROSS-REFERENCE TO RELATED APPLICATION

This application claims the benefit of Korean Patent Application No. KR 10-2025-00003187 filed on Jan. 9, 2025, which is hereby incorporated by reference herein in its entirety.

### BACKGROUND

### 1. Technical Field

The present invention relates to a method and system for estimating construction costs. More particularly, the present invention relates to a method and system for estimating construction costs by utilizing a Building Information Modeling (BIM) model and a graph neural network model.

### 2. Description of the Related Art

Building Information Modeling (BIM) refers to a method and system for managing building projects using three-dimensional (3D) models, unlike conventional drawing-based methods.

Industry Foundation Classes (IFC) refers to a standard format for exchanging BIM models between different types of BIM software, which is defined according to ISO 16739-1:2024.

Graph Neural Networks (GNNs) are a scheme for processing data represented in graph form using artificial neural networks.

Text embedding is a technology that converts string data into a computer-processable format. Various algorithms, such as Word2Vec and Glove, may be utilized to embed text so that it better expresses its meaning in latent space. Recently, large language models have also been used for embedding.

3D Boolean operations (geometric operations) refer to the processing of unions, differences, and intersections through Boolean operations on 3D geometric objects in computer graphics.

A conventional technology for a method of estimating construction costs is a technology utilizing the values, obtained by calculating “the unit prices×(the area, length, or number of items*the waste factor)” for individual cost units and then figuring out the aggregated sum thereof, for rough estimates. This conventional technology primarily relies on rough estimates based on the type of existing project, unit prices per length and area, and a waste allowance, resulting in a significant margin of error. For example, errors in estimates based on the schematic design phase may range from −30% to 50%. Such errors may result in differences ranging from hundreds of millions to tens of billions of Korean Won, particularly in large-scale construction projects.

A recent technology is a technology for constructing a unit price classification system for each building component. Major contractors have also adopted a method of pre-establishing a classification system and manually entering cost-affecting performance requirements for building components or type classification codes for internal management. Although this method offers relatively high accuracy, the classification process via manual work is time-consuming, making it difficult to utilize for exploring various alternatives for optimization.

### Related Art Literature

(Patent Document 1) Korean Patent No. 10-2695615 (published on Aug. 12, 2024)

### SUMMARY

A method and system for estimating construction costs by utilizing a BIM model and a graph neural network model according to the present invention have the following objects:

A first object of the present invention is to accurately extract the relations between building components within BIM design data and convert them into graph data.

A second object of the present invention is to construct and train a graph neural network for predicting the functional requirements and/or type classification codes of building components by processing graph data containing BIM design data.

A third object of the present invention is to predict the functional requirements and/or type classification codes of building components by inputting a new building project utilizing a trained graph neural network.

A fourth object of the present invention is to estimate construction costs by linking the predicted functional requirements and/or type classification codes of building components with the geometric information and unit price data of the building components.

The objects of the present invention are not limited to those mentioned above, and other objects not mentioned may be clearly understood by those skilled in the art from the following description.

According to an aspect of the present invention, there is provided a method of estimating construction costs by utilizing a BIM model and a graph neural network model, the method being performed by a control server having a database and a computational function, the method including: step S100 in which, at a graph data conversion unit, attribution information, including geometric information, functional requirements, and a type classification code for each building component within a BIM model, and connection information between individual building components are extracted, and the extracted attribute information and connection information are converted into a graph data format for graph neural network training; step S200 in which, at a graph neural network model learning unit, a graph neural network model for predicting functional requirements and a type classification code for each building component is trained and constructed by using the graph data, obtained by the conversion in step S100, as training data; step S300 in which, at a graph neural network model application unit, the geometric attribute information and connection information for each building component in the BIM model of a building project under analysis are extracted and converted into the graph data format, the converted data is input to the constructed graph neural network model to predict functional requirements and type classification codes, and the results of the prediction are then mapped to the BIM model under analysis; and step S400 in which, at a construction cost estimation unit, the attribute information of each building component is extracted from the mapped BIM model, a BOQ is generated for each building component, and the construction costs of the building project under analysis are calculated.

In step S100, the individual building components and the extracted attribute information for each building component may be stored in the nodes that constitute part of a graph.

In step S100, the relations between the individual building components extracted through three-dimensional (3D) Boolean operations may be stored in the connection information that constitutes part of a graph.

In step S200, the attribute information of the building component may be input to the graph neural network model, with at least one of a label-based embedding method, a one-hot-based embedding method, and a text embedding method being applied thereto, in which case embedding methods for the input and output may be either identical to or different from each other.

When the embedding methods for the input and output are different from each other, the text embedding method may be applied for one of the input and output.

In step S200, the text embedding method may be provided as a Large Language Model (LLM)-based text embedding method capable of incorporating semantic context information.

Step S300 may include: step S310 in which, at a conversion unit, the geometric attribute information for each building component in the BIM model under analysis and the connection information between individual building components are extracted and converted into graph data according to the graph conversion method of step S100; step S320 in which, at a prediction unit, the graph data obtained by the conversion in step S310 is input to the graph neural network model constructed in step S200, so that at least one of functional requirements and a type classification code for each building component is predicted; and step S330 in which, at a mapping unit, a mapped BIM model in which the attribute information predicted in step S320 has been reflected in the BIM model under analysis is derived.

In step S310, the BIM model under analysis may be provided as an initial BIM model.

Step S400 may include: step S410 in which, at an information extraction unit, at least one of functional requirements and a type classification code for each building component, and geometric attribute information for individual building components, are extracted from the mapped BIM model derived in step S330; step S420 in which, at a BOQ generation unit, a BOQ in which the attribute information extracted in step S410 has been reflected is generated; and step S430 in which, at an estimation unit, the construction costs of the building project under analysis are estimated by linking the BOQ generated in step S420 with a database in which unit price information has been previously stored.

According to another aspect of the present invention, there is provided a computer program stored on a computer-readable storage medium to execute the method of estimating construction costs by utilizing a Building Information Modeling (BIM) model and a graph neural network model 1 according to the present invention in conjunction with hardware.

According to still another aspect of the present invention, there is provided a system for estimating construction costs by utilizing a BIM model and a graph neural network model, the system including: a graph data conversion unit at which attribution information, geometric information, including functional requirements, and a type classification code for each building component within a BIM model, and connection information between individual building components are extracted and the extracted attribute information and connection information are converted into a graph data format for graph neural network training; a graph neural network model learning unit at which a graph neural network model for predicting functional requirements and a type classification code for each building component is trained and constructed by using the graph data, obtained by the conversion at the graph data conversion unit, as training data; a graph neural network model application unit at which the geometric attribute information and connection information for each building component in the BIM model of a building project under analysis are extracted and converted into the graph data format, the converted data is input to the constructed graph neural network model to predict functional requirements and type classification codes, and the results of the prediction are then mapped to the BIM model under analysis; and a construction cost estimation unit at which the attribute information of each building component is extracted from the mapped BIM model, a BOQ is generated for each building component, and the construction costs of the building project under analysis are calculated.

At the graph data conversion unit, the individual building components and the extracted attribute information for each building component may be stored in the nodes that constitute part of a graph.

At the graph data conversion unit, the relations between the individual building components extracted through three-dimensional (3D) Boolean operations may be stored in the connection information that constitutes part of a graph.

At the graph neural network model training unit, the attribute information of the building component may be input to the graph neural network model, with at least one of a label-based embedding method, a one-hot-based embedding method, and a text embedding method being applied thereto, in which case embedding methods for the input and output may be either identical to or different from each other.

When the embedding methods for the input and output are different from each other, the text embedding method may be applied for one of the input and output.

At the graph neural network model training unit, the text embedding method may be provided as a Large Language Model (LLM)-based text embedding method capable of incorporating semantic context information.

The graph neural network model application unit may include: a conversion unit at which the geometric attribute information of each building component in the BIM model under analysis and the connection information between the individual building components are extracted and converted into graph data according to the graph conversion method of the graph data conversion unit; a prediction unit at which the graph data obtained by the conversion at the conversion unit is input to the graph neural network model constructed at the graph neural network model training unit, so that at least one of functional requirements and a type classification code for each building component is predicted; and a mapping unit at which a mapped BIM model in which the attribute information predicted at the prediction unit has been reflected in the BIM model under analysis is derived.

At the invention conversion unit, the BIM model under analysis may be provided as an initial BIM model.

The construction cost estimation unit may include: an information extraction unit at which at least one of functional requirements and a type classification code for each building component, and geometric attribute information for individual building components, are extracted from the mapped BIM model derived at the mapping unit; a BOQ generation unit at which a BOQ in which the attribute information extracted at the information extraction unit has been reflected is generated; and an estimation unit at which the construction costs of the building project under analysis are estimated by linking the BOQ generated at the BOQ generation unit with a database in which unit price information has been previously stored.

The method and system for estimating construction costs by utilizing a BIM model and a graph neural network model according to the present invention have the following advantages:

First, the method of generating graph data by extracting the relations between building components through 3D Boolean operations on the building components, which is proposed by the present invention, provides the advantage of increasing the prediction accuracy of a graph neural network by generating more accurately expressed data than conventional methods utilizing IfcRelations or bounding boxes.

Second, the present invention provides the advantage of predicting the functional requirements and/or type classification codes of individual nodes corresponding to building components based on the relations between individual nodes and their neighboring nodes within a graph.

Third, the present invention provides the advantage of providing richer semantic data to graph neural network training than a conventional numeric labeling method by representing the current attribute values of building components as vector values through text embedding.

Fourth, the present invention provides the advantage of automating the process of converting a new building project into graph data, predicting the functional requirements or type classification codes of the individual components of the corresponding project via a trained graph neural network, and adding the results of the prediction as attribute information to components within a BIM model.

Fifth, the present invention provides the advantage of automatically generating a Bill of Quantities (BOQ) based on the functional requirements and/or type classification codes within a BIM model and the attribute information, such as widths, lengths, and areas, of geometric components and automatically estimating construction costs for an initial design plan by linking the BOQ with unit price information and a database.

The advantages of the present invention are not limited to those mentioned above, and other advantages not mentioned may be clearly understood by those skilled in the art from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart of a method of estimating construction costs by utilizing a BIM model and a graph neural network model according to the present invention;

FIG. 2 illustrates a graph conversion technology for BIM design data through 3D Boolean operations;

FIG. 3 illustrates a graph neural network training step for predicting the functional requirements or type classification codes of building components;

FIG. 4 illustrates the distances between encoding vectors and gTypes;

FIG. 5 illustrates step S300 of predicting component requirements or type classification codes within a new project based on a graph neural network; and

FIG. 6 illustrates step S400 of estimating the costs of a project by linking the predicted functional requirements and/or type classification codes of building components with the geometric information and unit price data of the building components.

### DETAILED DESCRIPTION

Embodiments of the present invention will be described with reference to the accompanying drawings below so that those having ordinary skill in the art to which the present invention pertains can readily practice the present invention. As will be readily understood by those having ordinary skill in the art to which the present invention pertains, the embodiments to be described below may be modified in various forms without departing from the spirit and scope of the present invention. Where possible, identical or similar portions are denoted using the same reference numerals in the drawings.

The terms used herein are solely intended for describing specific embodiments, and are not intended to limit the present invention. The singular forms used herein include plural forms unless the context clearly indicates otherwise.

The term “including” used herein is intended to specify particular features, regions, integers, steps, operations, elements, and/or components, and is not intended to exclude the presence or addition of other particular features, regions, integers, steps, operations, elements, components, and/or groups thereof.

All the terms, including technical and scientific terms, used herein have the same meanings as commonly understood by those having ordinary skill in the art to which the present invention pertains. The terms defined in the dictionaries are additionally interpreted as having meanings consistent with the relevant technical literature and the present disclosure, and are not to be construed as ideal or overly formal unless otherwise defined.

The directional expressions used herein, such as front/back/left/right, up/down, and vertical/horizontal, may be interpreted by referring to the directions disclosed in the drawings.

In building projects, it is important to determine the costs required in the future and the required performance for each component based on results from an initial design phase. A building project according to the present invention generally includes a building, but may include a bridge, a road, and other structures.

First, the gist of the present invention is briefly described as follows:

The present invention proposes a method of predicting functional requirements for building components or type classification codes only based on the relations between components present in a BIM model in an initial design stage by utilizing a graph neural network, and also proposes a method of estimating the construction costs of a building project by using the former method.

Step S100 corresponds to a technology for converting a BIM model into graph neural network training data or a new building project into graph data for processing via a graph neural network.

The conventional methods utilized to convert BIM models into graphs include an IfcRelation-based method and a bounding box-based method. The IFC-based method utilizes the IfcRelations defined by the IFC standard data format for BIM models. However, the IFC-based method has a problem in that these relations are frequently lost during conversion into standard models. The bounding box-based method is applicable to rectangular components. However, when whether there are connections is determined based on bounding boxes representing many building components (especially floors) as rectangular parallelepiped objects, distortion occurs in the following diagram.

In step S100 according to the present invention, the method of generating graph data by extracting the relations between building components through 3D Boolean operations on the building components generates more accurately expressed data than the IfcRelation-based method and the bounding box-based method, which are conventional methods, particularly during the process of extracting graph nodes and relations, thereby increasing the prediction accuracy of the graph neural network.

In step S300, a new building project is converted into graph data by using the method of step S100 and the required functions or classification codes of components within the project are predicted by using the graph neural network trained in step S200. This step may replace the previous labor-intensive task of manually classifying components. The predicted required functions or classification codes are reflected as the attribute information of components within the BIM model.

In step S400, the required functions or classification codes of the components and the geometric attributes thereof, including the widths, lengths, areas, and volumes thereof, are extracted from the BIM model in which the predicted results have been reflected, a BOQ is automatically generated, and estimation is automated by linking the BOQ with unit price information and a database.

The present invention will be described with reference to the drawings below. For reference, the drawings may be partially exaggerated to illustrate the features of the present invention. In this case, it is preferable to interpret them in light of the overall context of the present specification.

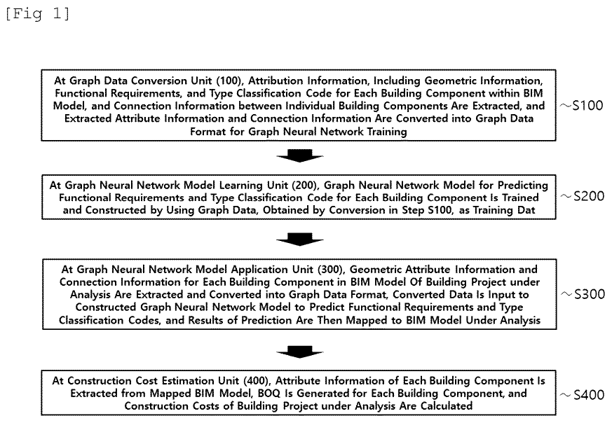

FIG. 1 is a flowchart of a method of estimating construction costs by utilizing a BIM model and a graph neural network model according to the present invention.

The present invention is directed to a method of estimating construction costs by utilizing a BIM model and a graph neural network model, which is performed by a control server having a database and a computational function. The method of estimating construction costs by utilizing a BIM model and a graph neural network model includes: step S100 in which, at a graph data conversion unit 100, attribution information, including geometric information, functional requirements, and a type classification code for each building component within a BIM model, and connection information between individual building components are extracted, and the extracted attribute information and connection information are converted into a graph data format for graph neural network training; step S200 in which, at a graph neural network model learning unit 200, a graph neural model network for predicting functional requirements and a type classification code for each building component is trained and constructed by using the graph data, obtained by the conversion in step S100, as training data; step S300 in which, at a graph neural network model application unit 300, the geometric attribute information and connection information for each building component in the BIM model of a building project under analysis are extracted and converted into the graph data format, the converted data is input to the constructed graph neural network model to predict functional requirements and type classification codes, and the results of the prediction are then mapped to the BIM model under analysis; and step S400 in which, at a construction cost estimation unit 400, the attribute information of each building component is extracted from the mapped BIM model, a BOQ is generated for each building component, and the construction costs of the building project under analysis are calculated.

Step S100 according to the present invention will be described below.

In step S100 according to the present invention, at the graph data conversion unit 100, attribute information including geometric information, functional requirements, and a type classification code for each building component within a BIM model, and connection information between individual building components may be extracted, and the extracted attribute information and connection information may be converted into a graph data format for graph neural network training.

In step S100, the individual building components and the extracted attribute information for each building component may be stored in nodes that constitute part of a graph.

The individual building components within the BIM model and their attributes may be stored in and extracted from the nodes, out of the nodes and relations that constitute the graph.

In this case, the building components refer to the elements that constitute parts of a building. Examples thereof include walls, columns, slabs, and beams.

In this case, the attributes refer to the geometric information, functional requirements, and type classification codes of the building components.

The geometric information refers to the widths, lengths, areas, and volumes of the building components, and these requirements influence the unit prices of the building components.

The functional requirements encompass requirements that specifically influence unit cost estimation, such as insulation, waterproofing, structural requirements, rebar placement and dimensions, and/or the like, which are functionally required for the building components. These requirements may vary depending on the purpose of the building project.

The type classification codes pertain to a classification system for separately managing requirements for individual building components. It may be utilized when it is established in advance.

Table 1 below illustrates an example of the type classification code system. The “Code” denotes the type classification code, the “Subtype” denotes the classification name, and the “Functional Property” denotes the functional requirements.

TABLE 1

| | Generic | | Functional Property | | |
|---|---|---|---|---|---|
| Code | Type | Subtype | Insulation | Waterproofing | Loadbearing |
| 0 | Wall | Core wall | — | — | Required |
| 1 | Wall | Horizontal wall | — | — | Required |
| 2 | Wall | Vertical wall | — | — | Required |
| 3 | Wall | Perimeter wall | Required | Required | Required |
| 4 | Wall | Side wall | Required | Required | Required |
| 5 | Wall | Entrance retaining wall | — | — | Required |
| 6 | Wall | Loadbearing retaining | — | — | Required |
| | | wall | | | |
| 7 | Wall | Miscellaneous wall | — | — | Required |
| 8 | Wall | Unit partition wall | — | — | — |
| 9 | Wall | Non-loadbearing wall | — | — | — |
| 10 | Wall | Auxiliary space wall | — | — | Required |
| 11 | Wall | Roof ornamental wall | — | — | — |
| 12 | Wall | Roof parapet wall | Required | Required | — |
| 13 | Wall | Penthouse parapet wall | Required | Required | — |
| 14 | Wall | Ramp parapet wall | — | — | Required |
| 15 | Wall | Balcony parapet wall | — | — | — |
| 16 | Wall | Miscellaneous parapet | — | — | — |
| | | wall | | | |
| 17 | Column | Transfer column | — | — | Required |
| 18 | Beam | Core beam | — | — | Required |
| 19 | Beam | Transfer beam | — | — | Required |
| 20 | Beam | Miscellaneous beam | — | — | Required: |
| 21 | Beam | Wall girder | — | — | Required |
| 22 | Beam | Interior lintel | — | — | Required |
| 23 | Beam | Non-loadbearing lintel | — | — | — |
| 24 | Stairs | Entrance stairs | — | — | Required |
| 25 | Stairs | Interior stairs | — | — | Required |
| 26 | Slab | Core slab | Required | — | Required |
| 27 | Slab | Entrance slab | — | — | Required |
| 28 | Slab | Entrance ramp slab | — | — | Required |
| 29 | Slab | Pilotis slab | — | — | Required |
| 30 | Slab | Basement utility pit slab | — | Required | Required |
| 31 | Slab | Interior slab | — | — | Required |
| 32 | Slab | Bathroom slab | — | Required | Required |
| 33 | Slab | Miscellaneous slab | — | — | Required |
| 34 | Slab | Auxiliary space slab | — | — | Required |
| 35 | Slab | Penthouse interior slab | Required | Required | Required |
| 36 | Slab | Penthouse core slab | Required | Required | Required |
| 37 | Slab | Roof ornamental slab | — | — | — |
| 38 | Slab | Canopy slab | — | — | Required |
| 39 | Foundation | Entrance strip foundation | — | — | Required |
| 40 | Foundation | Mat foundation | — | — | Required |
| 41 | Foundation | Haunch | — | — | Required |

For reference, in the case of the graph data used for model training, functional requirements or classification codes are extracted and stored. The reason for this is that the purpose of model training is to predict functional requirements or classification codes based on geometric information of a new building project. In contrast, in the case of prediction for a new building project, only geometric information is extracted.

Out of the attribute information, at least one of the functional requirements and the type classification codes needs to be extracted to train a graph neural network model for construction cost estimation. The extraction of both of them may also be desirable for construction cost estimation.

The attribute information is separately generated by writing the codes that describe the information of building components within the BIM model, and the information already stored in a database may be utilized for the attribute information.

In step S100, the relations between the individual building components extracted through 3D Boolean operations may be stored in the connection information that constitutes part of a graph.

Conventionally, Boolean operation method based on relations in the IFC format has been utilized. However, this method has a problem in that omissions easily occur during data changes.

Furthermore, a Boolean operation method based on bounding boxes has also been utilized. However, this method has a problem in that it is difficult to accurately incorporate relations for components having different shapes other than rectangular parallelepiped components.

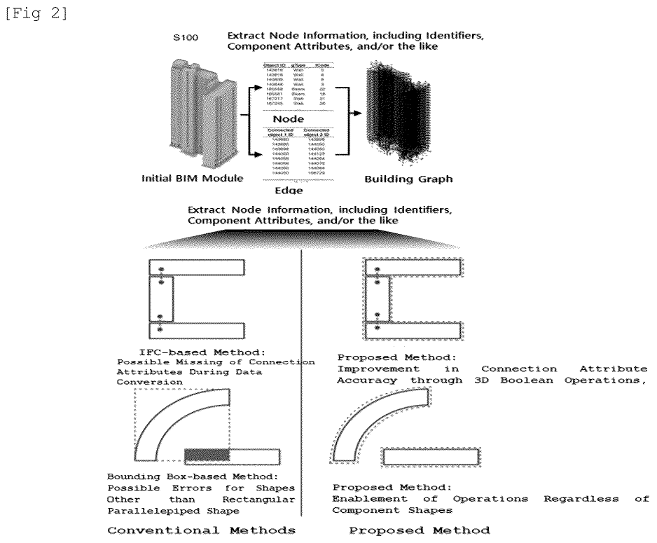

FIG. 2 illustrates a graph conversion technology for BIM design data through 3D Boolean operations.

Out of the conventional methods shown in FIG. 2, the IFC-based method is a standard for BIM data exchange. However, this method has a possibility of information loss or omission during the import and export process in BIM software, so that a problem regarding interoperability may occur. Furthermore, even when components are modeled to be considerably close to each other, relations may not be generated when they are not connected to each other. In reality, it is reasonable to view such components as connected to each other.

Out of the conventional methods shown in FIG. 2, the bounding box-based method generates minimum boundaries that encompass all the outlines. It is shown that when an intersection area is calculated based on this method, a portion in which no component is present may also be calculated as a portion of an intersection area.

Accordingly, according to the present invention, the relations between individual building components are extracted using a 3D Boolean operation method.

Step S200 according to the present invention will be described below.

In step S200 according to the present invention, at a graph neural network model training unit 200, a graph neural network model that predicts functional requirements and a type classification code for each building component may be trained and constructed by using the graph data, obtained by the conversion in step S100, as training data.

A graph neural network is a model that consists of an input layer group, one or more hidden layer groups, and an output layer group and processes graph-type data. In this case, the individual layer groups generally function as an input layer, hidden layers, and an output layer, but the specific combination thereof may vary.

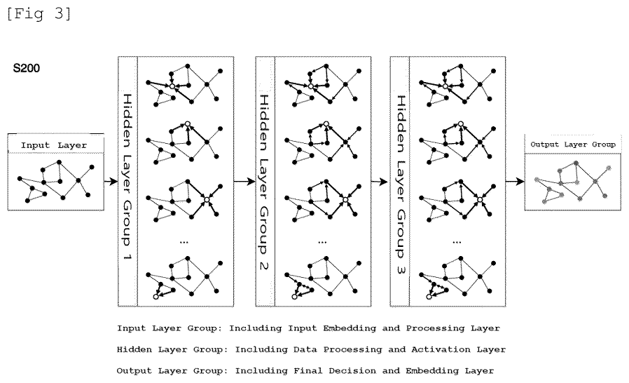

FIG. 3 illustrates a graph neural network training step for predicting the functional requirements or type classification codes of building components.

The example of FIG. 3 presents the structure of a graph neural network that classifies a target component or predicts attributes based on the relations with nodes up to a third distance via three hidden layers.

To predict the functional requirements of a single building component, whether to determine the relation with a building component a few steps away may vary depending on the specific graph neural network structure.

That is, in the case of the graph neural network, graph neural networks having various structures may be used for node classification and attribute prediction.

In the case of the present invention, when the attribute information of a building component is input to the graph neural network, the model may process the semantic information of the attributes of the building component by using text embedding (including large language model embedding) as well as a conventional label- or one-hot-based embedding method. Similar and different attributes may be better distinguished from each other by using this approach.

In step S200, the attribute information of the building component may be input to the graph neural network model, with at least one of a label-based embedding method, a one-hot-based embedding method, and a text embedding method being applied thereto, in which case embedding methods for the input and output may be either identical to or different from each other. Furthermore, when the embedding methods for the input and output are different from each other, the text embedding method may be applied for one of the input and output.

Embedding is a technique for how to represent existing words or concepts to a computer. In the case of an AI model, formats for the input and output are embedded. In the present invention, the embedding methods for input and output may be different from each other.

In the present invention, when the same embedding method is applied for both the input and output, this means that any one of a label-based embedding method, a one-hot-based embedding method, and a text embedding method is applied for both the input and output.

In the present invention, the use of different methods for the input and output means, for example, applying a label-based embedding method for the input and a text embedding method for the output.

In particular, when a text embedding method is applied for at least one of the input and output, the sizes of the input/output layers need to be adjusted as needed in the architecture of an artificial neural network, and the loss function and activation layer need to be adjusted accordingly during training. However, this adjustment has the advantage of allowing for the more accurate prediction of the specific types or required performance of building components depending on the context.

In step S200, the text embedding method is preferably a Large Language Model (LLM)-based text embedding method capable of incorporating semantic context information.

Table 2 below shows examples of input embedding types.

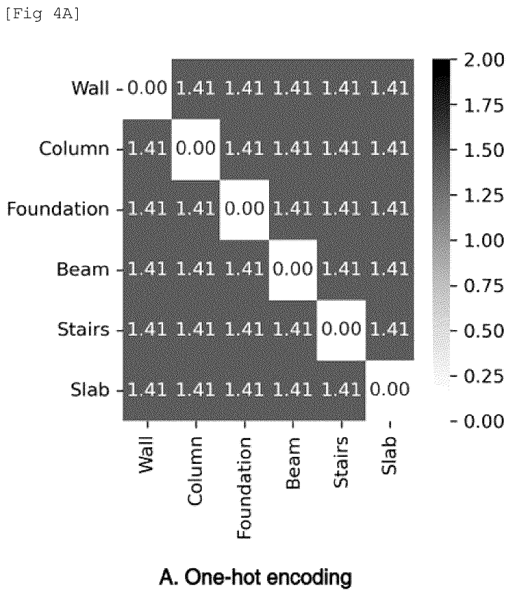

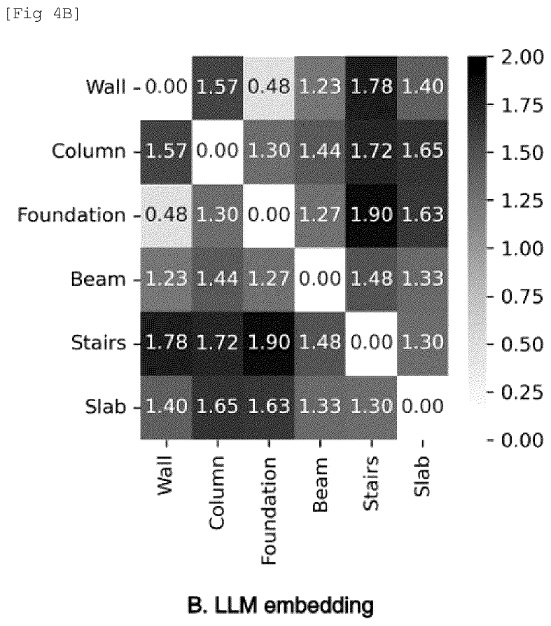

FIG. 4 illustrates the distances between encoding vectors and gTypes.

TABLE 2

| Component | | | |
|---|---|---|---|
| attribute | Label | One-hot | |
| (category) | encoding | encoding | LLM embedding |
| Wall | 0 | [1, 0, 0, 0, 0, 0] | [−0.1625, −0.2223, 0.2909, 0.8468, −0.2658, −0.2278] |
| Column | 1 | [0, 1, 0, 0, 0, 0] | [0.2784, 0.0874, 0.7927, −0.3196, 0.4285, 0.0274] |
| Foundation | 2 | [0, 0, 1, 0, 0, 0] | [0.0227, −0.2294, 0.4849, 0.7475, 0.0910, −0.3804] |
| Beam | 3 | [0, 0, 0, 1, 0, 0] | [0.8013, −0.0436, 0.0208, 0.3886, −0.3593, 0.2746] |
| Stairs | 4 | [0, 0, 0, 0, 1, 0] | [−0.0398, −0.2890, −0.6403, −0.5983, −0.3252, 0.2031] |

Embedding relates to how distinct the types (e.g., walls, columns, foundations, beams, staircases, and floors) of individual building components (building elements) are from each other in terms of how AI perceives them.

For example, in the one-hot encoding of FIG. 4A, individual building elements are each represented by either 0 or 1 in the form of a 6-dimensional vector, resulting in an identical distance of 1.41 between them. In contrast, when text embedding from a large language model is utilized, as shown in FIG. 4B, types having relatively similar roles may be represented as being closer to each other. For example, a foundation appears closer to a wall because it also contains a foundation wall.

Step S300 according to the present invention will be described below.

In step S300 according to the present invention, at the graph neural network model application unit 300, the geometric attribute information and connection information for each building component in the BIM model of a building project under analysis may be extracted and converted into the graph data format, the converted data may be input to the constructed graph neural network model to predict functional requirements and type classification codes, and the results of the prediction may then be mapped to the BIM model under analysis.

Step S300 may be divided into the following sub-steps and then performed.

In step S310, at a conversion unit 310, the geometric attribute information for each building component in the BIM model under analysis and the connection information between individual building components may be extracted and converted into graph data according to the graph conversion method of step S100.

In step S320, at a prediction unit 320, the graph data obtained by the conversion in step S310 may be input to the graph neural network model constructed in step S200, so that at least one of functional requirements and a type classification code for each building component is predicted.

In step S330, at a mapping unit 330, a mapped BIM model in which the attribute information predicted in step S320 has been reflected in the BIM model under analysis may be derived.

In step S310, the BIM model under analysis may be an initial BIM model.

As for the output information of step S310, relations with the building components (nodes) may be extracted in a graph form, and geometric information may be added as node attributes.

In further detail, the initial BIM model of the new building project is converted into a graph according to the graph conversion method of step S100 in step S310, requirements or classification codes to be applied to individual building components (e.g., nodes within the graph) are predicted by utilizing the trained graph neural network of step S200 in step S320, and the results of the prediction are reflected in the initial BIM model of the new project in step S330.

In this case, the new model is input to the interface of a BIM model authoring tool. As step S100 is performed, conversion into graph data is performed outside the interface (at a backend). In step S200, the node attributes and classification are performed using a pre-trained graph neural network, and the results of the performance are then reflected back into the interface of the BIM authoring tool.

Step S320 utilizes the learning model completed via step S200. In step S320, a new building project for which correct answers are unknown (for which prediction is desired) is input to the completed learning model, and functional requirements and type classification codes are output out of the attribute information of corresponding building components.

Step S330 is the step of, while iterating over individual components in the initial BIM model, adding details based on predicted requirements or changing the detailed types of components according to classification codes.

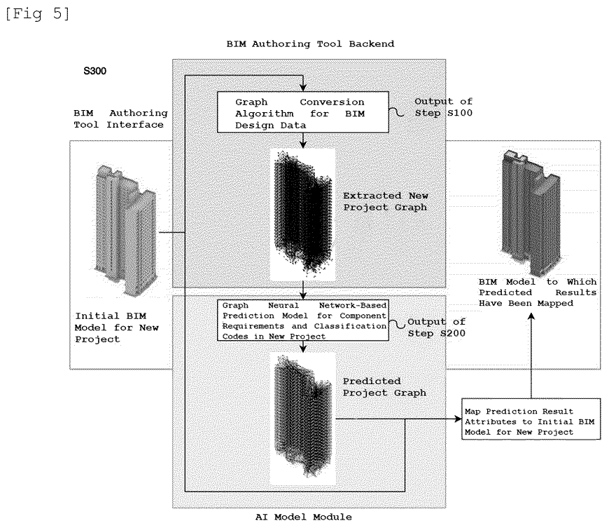

FIG. 5 illustrates step S300, in which component requirements or type classification codes within a new project are predicted based on a graph neural network. Step S300 is the step of utilizing a completed learning model. Step S300 refers to the step of inputting a new building project, for which prediction is desired because correct answers are unknown, to the completed learning model, outputting functional requirements and type classification codes, out of the attribute information of each corresponding building component, as output information, and adding details based on the predicted requirements to the initial BIM model of the new building project or changing the detailed type of component based on the classification code.

Step S400 according to the present invention will be described below.

In step S400 according to the present invention, at the construction cost estimation unit 400, attribute information of each building component may be extracted from the mapped BIM model, a BOQ may be generated for each building component, and the construction costs of the building project under analysis may be calculated.

Step S400 may be divided into the following sub-steps and then performed.

In step S410, at an information extraction unit 410, at least one of functional requirements and a type classification code for each building component, and geometric attribute information for individual building components, may be extracted from the mapped BIM model derived in step S330.

In step S420, at a BOQ generation unit 420, a BOQ in which the attribute information extracted in step S410 has been reflected may be generated.

In step S430, at an estimation unit 430, the construction costs of the building project under analysis may be estimated by linking the BOQ generated in step S420 with a database in which unit price information has been previously stored.

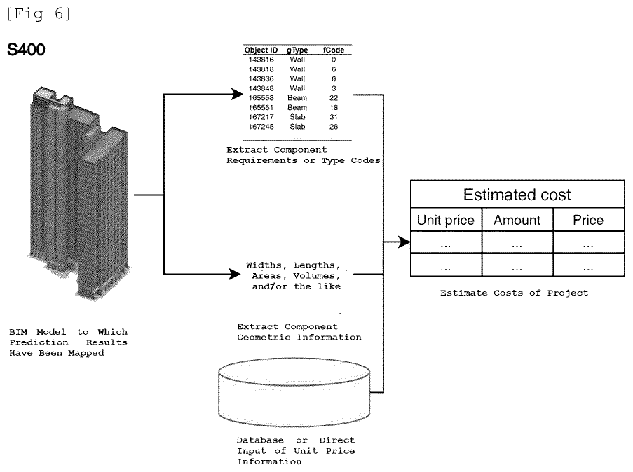

FIG. 6 illustrates step S400 of estimating the costs of a project by linking the predicted functional requirements and/or type classification codes of building components with the geometric information and unit price data of the building components.

Step S400 is the step of extracting component geometric information for cost estimation from the BIM model in which details based on predicted requirements are added or the detailed types of components are changed based on type classification codes and generating an estimate while operating in conjunction with a unit price information database.

Furthermore, the present invention may be implemented as a computer program. More specifically, the present invention may be implemented as a computer program stored on a computer-readable storage medium to execute the method of estimating construction costs by utilizing a BIM model and a graph neural network model according to the present invention via a computer in conjunction with hardware.

The methods according to the embodiments of the present invention may be implemented in the form of programs readable via various computer means and recorded on a computer-readable storage medium. In this case, the storage medium may include program instructions, data files, data structures, and the like, either individually or in combination. The program instructions recorded on the storage medium may be those specifically designed and configured for the present invention, or may be known and usable by those skilled in the computer software art. For example, the storage medium may include: magnetic media such as a hard disk, a floppy disk, and magnetic tape; optical media such as CDROM and a DVD; magneto-optical media such as a floptical disk; and hardware devices specifically configured to store and execute program instructions, such as ROM and flash memory. Examples of the program instructions may include not only machine languages generated by a compiler, but also high-level languages executed by a computer via an interpreter or the like. These hardware devices may be configured to operate as one or more software modules to perform the operations of the present invention, and vice versa.

Meanwhile, the present invention may be implemented as a system for estimating construction costs. More specifically, the present invention may be implemented as a system for estimating construction costs by utilizing a BIM model and a graph neural network model.

Although this system invention differs in the category of invention from the above-described method invention, their technical structures are substantially the same as each other. Accordingly, a description of the technical structure of the system invention that is substantially the same as that of the method invention will be replaced with the above description of the technical structure of the method invention, and the following description will be given with a focus on the gist of the system invention.

The present invention is directed to a system for estimating construction costs by utilizing a BIM model and a graph neural network model. The system for estimating construction costs by utilizing a BIM model and a graph neural network model includes: a graph data conversion unit 100 at which attribution information, including geometric information, functional requirements, and a type classification code for each building component a within BIM model, and connection information between individual building components are extracted and the extracted attribute information and connection information are converted into a graph data format for graph neural network training; a graph neural network model learning unit 200 at which a graph neural network model for predicting functional requirements and a type classification code for each building component is trained and constructed by using the graph data, obtained by the conversion at the graph data conversion unit 100, as training data; a graph neural network model application unit 300 at which the geometric attribute information and connection information for each building component in the BIM model of a building project under analysis are extracted and converted into the graph data format, the converted data is input to the constructed graph neural network model to predict functional requirements and type classification codes, and the results of the prediction are then mapped to the BIM model under analysis; and a construction cost estimation unit 400 at which the attribute information of each building component is extracted from the mapped BIM model, a BOQ is generated for each building component, and the construction costs of the building project under analysis are calculated.

At the graph data conversion unit 100 according to the present invention, the individual building components and the extracted attribute information for each building component may be stored in nodes that constitute part of a graph.

At the graph data conversion unit 100 according to the present invention, the relations between the individual building components extracted through 3D Boolean operations may be stored in the connection information that constitutes part of a graph.

At the graph neural network model training unit 200 according to the present invention, the attribute information of the building component may be input to the graph neural network model, with at least one of a label-based embedding method, a one-hot-based embedding method, and a text embedding method being applied thereto, in which case embedding methods for the input and output may be either identical to or different from each other.

When different embedding methods are applied for the input and output, the text embedding method may be applied for one of the input and output.

At the graph neural network model training unit 200 according to the present invention, the text embedding method may be provided as an LLM-based text embedding method capable of incorporating semantic context information.

The graph neural network model application unit 300 according to the present invention may include: the conversion unit 310 at which the geometric attribute information of each building component in the BIM model under analysis and the connection information between the individual building components are extracted and converted into graph data according to the graph conversion method of the graph data conversion unit 100; the prediction unit 320 at which the graph data obtained by the conversion at the conversion unit 310 is input to the graph neural network model constructed at the graph neural network model training unit 200 and at least one of functional requirements and a type classification code for each building component is predicted; and the mapping unit 330 at which a mapped BIM model in which the attribute information predicted at the prediction unit 320 has been reflected in the BIM model under analysis is derived.

At the conversion unit 310 according to the present invention, the BIM model under analysis may be provided as an initial BIM model.

The construction cost estimation unit 400 according to the present invention may include: the information extraction unit 410 at which at least one of functional requirements and a type classification code for each building component, and geometric attribute information for individual building components, are extracted from the mapped BIM model derived at the mapping unit 330; the BOQ generation unit 420 at which a BOQ in which the attribute information extracted at the information extraction unit 410 has been reflected is generated; and the estimation unit 430 at which the construction costs of the building project under analysis are estimated by linking the BOQ generated at the BOQ generation unit 420 with a database in which unit price information has been previously stored.

The embodiments described herein and the accompanying drawings merely illustrate some of the technical spirit encompassed by the present invention. Accordingly, the embodiments disclosed herein are intended to illustrate, rather than limit, the technical spirit of the present invention. Therefore, it is obvious that the scope of the technical spirit of the present invention is not limited by these embodiments. All modifications and specific embodiments that can be easily inferred by those having ordinary skill in the art within the scope of the technical spirit included in the present specification and the accompanying drawings should be interpreted as being included in the scope of the present invention.

What is claimed is:

1. A method of estimating construction costs by utilizing a Building Information Modeling (BIM) model and a graph neural network model, the method being performed by a control server having a database and a computational function, the method including:
step S100 in which, at a graph data conversion unit, attribution information, including information, functional requirements, and a type classification code for each building component within BIM model, and connection a information between individual building components are extracted, and the extracted attribute information and connection information are converted into a graph data format for graph neural network training;
step S200 in which, at a graph neural network model learning unit, a graph neural network model for predicting functional requirements and a type classification code for each building component is trained and constructed by using the graph data, obtained by the conversion in step S100, as training data;
step S300 in which, at a graph neural network model application unit, the geometric attribute information and connection information for each building component in the BIM model of a building project under analysis are extracted and converted into the graph data format, the converted data is input to the constructed graph neural network model to predict functional requirements and type classification codes, and the results of the prediction are then mapped to the BIM model under analysis; and
step S400 in which, at a construction cost estimation unit, attribute information of each building component is extracted from the mapped BIM model, a Bill of Quantities (BOQ) is generated for each building component, and construction costs of the building project under analysis are calculated.

2. The method of claim 1, wherein, in step S100, the individual building components and the extracted attribute information for each building component are stored in nodes that constitute part of a graph.

3. The method of claim 1, wherein, in step S100, relations between the individual building components extracted through three-dimensional (3D) Boolean operations are stored in connection information that constitutes part of the graph.

4. The method of claim 1, wherein, in step S200, the attribute information of the building component is input to the graph neural network model, with at least one of a label-based embedding method, a one-hot-based embedding method, and a text embedding method being applied thereto, in which case embedding methods for the input and output are either identical to or different from each other.

5. The method of claim 4, wherein, when the embedding methods for the input and output are different from each other, the text embedding method is applied for one of the input and output.

6. The method of claim 1, wherein, in step S200, the text embedding method is provided as a Large Language Model (LLM)-based text embedding method capable of incorporating semantic context information.

7. The method of claim 1, wherein step S300 comprises:
step S310 in which, at a conversion unit, the geometric attribute information for each building component in the BIM model under analysis and the connection information between individual building components are extracted and converted into graph data according to a graph conversion method of step S100;
step S320 in which, at a prediction unit, the graph data obtained by the conversion in step S310 is input to the graph neural network model constructed in step S200, so that at least one of functional requirements and a type classification code for each building component is predicted; and
step S330 in which, at a mapping unit, a mapped BIM model in which the attribute information predicted in step S320 has been reflected in the BIM model under analysis is derived.

8. The method of claim 7, wherein, in step S310, the BIM model under analysis is provided as an initial BIM model.

9. The method of claim 7, wherein step S400 comprises:
step S410 in which, at an information extraction unit, at least one of functional requirements and a type classification code for each building component, and geometric attribute information for individual building components, are extracted from the mapped BIM model derived in step S330;
step S420 in which, at a BOQ generation unit, a BOQ in which the attribute information extracted in step S410 has been reflected is generated; and
step S430 in which, at an estimation unit, the construction costs of the building project under analysis are estimated by linking the BOQ generated in step S420 with a database in which unit price information has been previously stored.

10. A computer program stored on a computer-readable storage medium to execute the method of estimating construction costs by utilizing a Building Information Modeling (BIM) model and a graph neural network model according to claim 1 in conjunction with hardware.

11. A system for estimating construction costs by utilizing a Building Information Modeling (BIM) model and a graph neural network model, the system comprising:
a graph data conversion unit which attribution information, including geometric information, functional requirements, and a type classification code for each building component within a BIM model, and connection information between individual building components are extracted and the extracted attribute information and connection information are converted into a graph data format for graph neural network training;
a graph neural network model learning unit at which a graph neural network model for predicting functional requirements and a type classification code for each building component is trained and constructed by using the graph data, obtained by the conversion at the graph data conversion unit, as training data;
a graph neural network model application unit at which the geometric attribute information and connection information for each building component in the BIM model of a building project under analysis are extracted and converted into the graph data format, the converted data is input to the constructed graph neural network model to predict functional requirements and type classification codes, and results of the prediction are then mapped to the BIM model under analysis; and
a construction cost estimation unit at which attribute information of each building component is extracted from the mapped BIM model, a Bill of Quantities (BOQ) is generated for each building component, and construction costs of the building project under analysis are calculated.

12. The system of claim 11, wherein, at the graph data conversion unit, the individual building components and the extracted attribute information for each building component are stored in nodes that constitute part of a graph.

13. The system of claim 11, wherein, at the graph data conversion unit, relations between the individual building components extracted through three-dimensional (3D) Boolean operations are stored in connection information that constitutes part of the graph.

14. The system of claim 11, wherein, at the graph neural network model training unit, the attribute information of the building component is input to the graph neural network model, with at least one of a label-based embedding method, a one-hot-based embedding method, and a text embedding method being applied thereto, in which case embedding methods for the input and output are either identical to or different from each other.

15. The system of claim 14, wherein, when the embedding methods for the input and output are different from each other, the text embedding method is applied for one of the input and output.

16. The method of claim 11, wherein, at the graph neural network model training unit, the text embedding method is provided as a Large Language Model (LLM)-based text embedding method capable of incorporating semantic context information.

17. The system of claim 11, wherein the graph neural network model application unit comprises:
a conversion t which the geometric attribute information of each building component in the BIM model under analysis and the connection information between the individual building components are extracted and converted into graph data according to a graph conversion method of the graph data conversion unit;
a prediction unit at which the graph data obtained by the conversion at the conversion unit is input to the graph neural network model constructed at the graph neural network model training unit, so that at least one of functional requirements and a type classification code for each building component is predicted; and
a mapping unit at which a mapped BIM model in which the attribute information predicted at the prediction unit has been reflected in the BIM model under analysis is derived.

18. The system of claim 17, wherein, at the conversion unit, the BIM model under analysis is provided as an initial BIM model.

19. The system of claim 17, wherein the construction cost estimation unit comprises:
an information extraction unit at which at least one of functional requirements and a type classification code for each building component, and geometric attribute information for individual building components, are extracted from the mapped BIM model derived at the mapping unit;
a BOQ generation unit at which a BOQ in which the attribute information extracted at the information extraction unit has been reflected is generated; and
an estimation unit at which the construction costs of the building project under analysis are estimated by linking the BOQ generated at the BOQ generation unit with a database in which unit price information has been previously stored.
